(19) United States
(12) Patent Application Publication
(10) Pub. No.: US 2011/0273180 A1
(43) Pub. Date: Nov. 10, 2011

(54) BATTERY TESTING METHOD

(76) Inventors: Mansik Park, North York (CA); Dirkmann Lee, Ajax (CA)

(21) Appl. No.: 12/776,332

(22) Filed: May 7, 2010

(51) Int. Cl. G01N 27/416

(52) U.S. Cl. 324/427

(57) ABSTRACT

The present invention allows batteries to be tested in conjunction with being re-charged, and identifies failed or failing batteries before they are put to further use. The present invention can simultaneously test and charge multiple batteries, and can simultaneously test and charge different types of batteries. A method according to various aspects of the present invention comprises: identifying, by a computer system comprising a user interface, a provided battery to be tested; receiving, through the user interface, a selection one or more tests to perform on the battery; and performing, using a battery testing system, the one or more tests on the battery. In this method, the battery testing system is in communication with the computer system, and the battery testing system comprises a battery interface for coupling with the battery.

### FIELD OF THE INVENTION

The present invention relates to systems and methods for testing batteries.

### BACKGROUND OF THE INVENTION

Rechargeable batteries are used in many different devices and can provide a significantly longer service life than disposable batteries. In some devices, particularly portable electronic devices like mobile telephones and laptop computers, rechargeable batteries are the main power source for the device. In other devices, such as cable modems or cable telephone adapters (also known as Embedded Multimedia Terminal Adapters or “EMTAs”), rechargeable batteries are used as a backup power source.

While rechargeable batteries can be recharged many times, eventually the performance of the battery will deteriorate to the point where it must be replaced. For some devices, it can be a relatively simple matter to obtain and replace a rechargeable battery. For other devices, the replacement of rechargeable batteries can be relatively difficult, expensive, and/or time-consuming.

For example, many cable modems and EMTAs include a rechargeable battery contained within their housings. The type of battery used in a cable modem or EMTA can vary depending on the manufacturer and model of the device, and these batteries are relatively expensive and can be difficult for the average consumer to obtain. Additionally, the housing of the cable modem or EMTA must be disassembled in order to replace the battery. Furthermore, since cable system operators are often responsible for maintaining cable modems and EMTAs deployed to customers, battery failures often result in the cable operator having to make a costly service call to address the issue.

The present invention addresses these and other issues.

### SUMMARY OF THE INVENTION

The present invention allows batteries to be tested in conjunction with being re-charged, and identifies failed or failing batteries before they are put to further use. The present invention can simultaneously test and charge multiple batteries, and can simultaneously test and charge different types of batteries.

A method according to various aspects of the present invention comprises: identifying, by a computer system comprising a user interface, a provided battery to be tested; receiving, through the user interface, a selection one or more tests to perform on the battery; and performing, using a battery testing system, the one or more tests on the battery. In this method, the battery testing system is in communication with the computer system, and the battery testing system comprises a battery interface for coupling with the battery.

Both the foregoing summary and the following detailed description are exemplary and explanatory only and are not restrictive of the invention.

### BRIEF DESCRIPTION OF THE DRAWINGS

A more complete understanding of the present invention may be derived by referring to the detailed description and claims when considered in connection with the following illustrative figures.

FIG. 1 is a block diagram depicting an exemplary system according to various aspects of the present invention.

FIG. 2 is a flow diagram depicting an exemplary process according to various aspects of the present invention.

FIGS. 3A-3C, 4, and 5 depict exemplary displays of information according to various aspects of the present invention.

FIGS. 6A-6C are perspective views of an exemplary battery testing module operating with different types of batteries.

FIG. 6D is a block diagram illustrating an exemplary battery tester according to various aspects of the present invention.

### DETAILED DESCRIPTION OF EXEMPLARY EMBODIMENTS

### Exemplary System

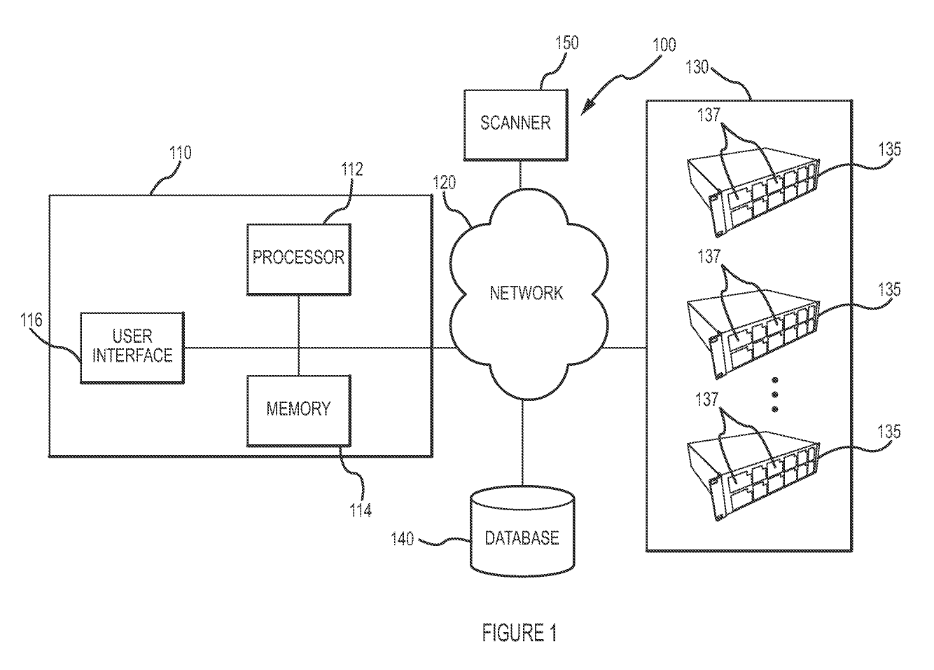

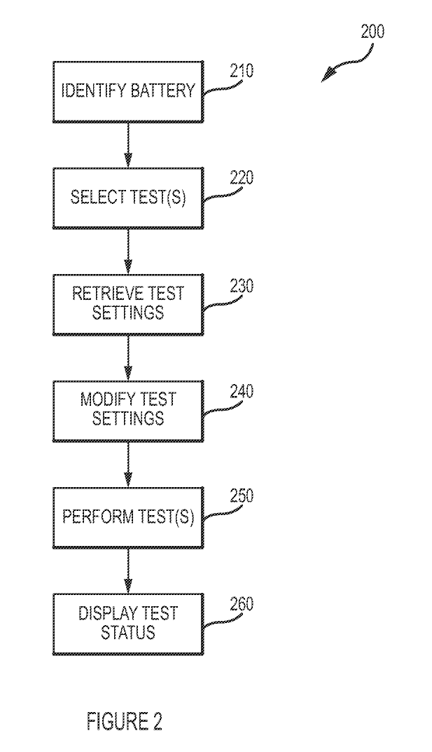

An exemplary system of the present invention is depicted in FIG. 1. This system may be used in conjunction with the method described in FIG. 2, as well as with any subset or combination of the elements thereof. The system shown in FIG. 1 may also be used in conjunction with any other suitable embodiments of systems and methods of the present invention.

The exemplary system 100 depicted in FIG. 1 comprises a control system 110 in communication with a battery testing system 130 via network 120. The control system includes a processor 112, memory 114, and user interface 116. The battery testing system 130 includes one or more battery testing modules (also referred to herein as “chassis”) 135, each with one or more battery interfaces 137. In this exemplary embodiment, the control system 110 and battery testing system 130 are in communication with a database 140 that stores information related to the testing of batteries. The system 100 allows multiple batteries to be tested simultaneously, and the tests to be configured and monitored through the control system 110.

### Control System 110

The control system 110 allows a user to initiate, configure, monitor, and review battery tests performed by the battery testing system 130. The control system 110 may include any number and type of computer systems, such as computer workstations, minicomputers, mainframe computers and/or handheld computers (including wireless devices such as personal digital assistants (PDAs) or mobile phones). A control system 110 used in accordance with aspects of the present invention may include an operating system (e.g., MICROSOFT Windows, IBM OS2, UNIX, Linux, Solaris, MAC OS, etc.) as well as various conventional support software and drivers typically associated with computers.

### Processor 112

The processor 110 retrieves and executes instructions stored in the memory 120 to control the operation of the control system 110. The processor 110 may include any number or type of computer processors, such as an integrated circuit microprocessor or microcontroller.

### Memory 114

The memory 114 stores instructions, test settings, test results, and any other suitable information. A memory operating in conjunction with the present invention may include any combination of different memory storage devices, such as hard drives, storage area networks (SANs) (e.g., disk arrays, tape libraries, optical jukeboxes), networked attached storage (NAS), NAS-SAN hybrid systems, random access memory (RAM), read only memory (ROM), FLASH memory, or any other type of volatile and/or nonvolatile memory.

### User Interface 116

The user interface 116 may include any number and type of input devices (not shown) to receive commands, data, and other suitable input from a user, as well as any number of output devices (not shown) to provide the user with test status information and other information.

For example, the user interface 116 may include input devices such as a touch pad, a touch screen, and/or an alphanumeric keypad to allow a user to enter instructions to initiate battery tests, modify test settings, and select test results for review. The user interface may also include a microphone to allow the user to provide audio data or voice commands to the control system 110. The control system 110 may include speech recognition software to process verbal input through the user interface 116.

The user interface 116 may also include any number of suitable output devices, such as a display screen to visually display information (such as video and text), and/or a speaker to provide auditory output. The mobile device 800 may be configured to provide words, phrases, tones, recorded music, or any other type of auditory output to a user through the speaker. In one exemplary embodiment, the user interface 116 includes one or more printers (not shown). Such printers can be used for printing hardcopies of test data, as well as to print barcodes (e.g., onto stickers) for use in tracking, packaging, and shipping batteries.

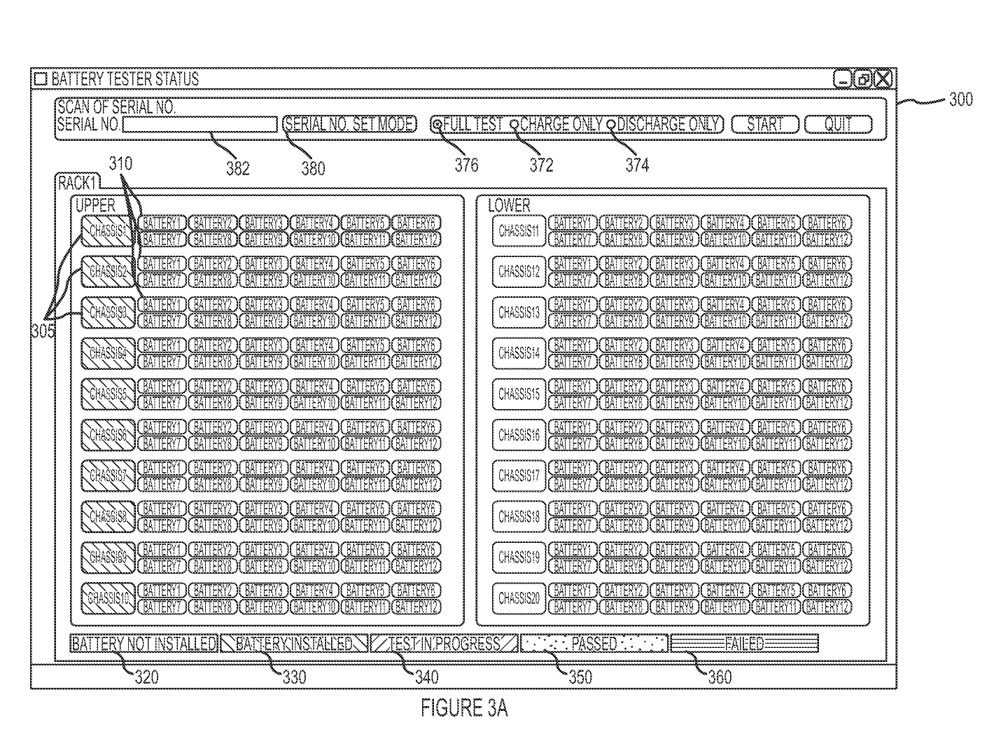

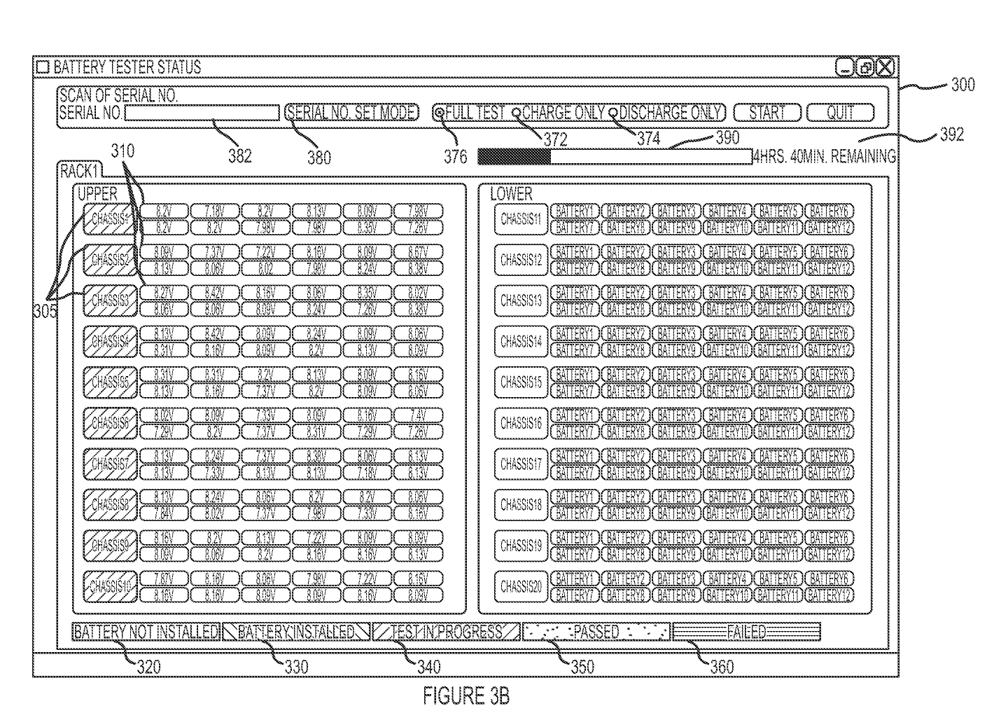

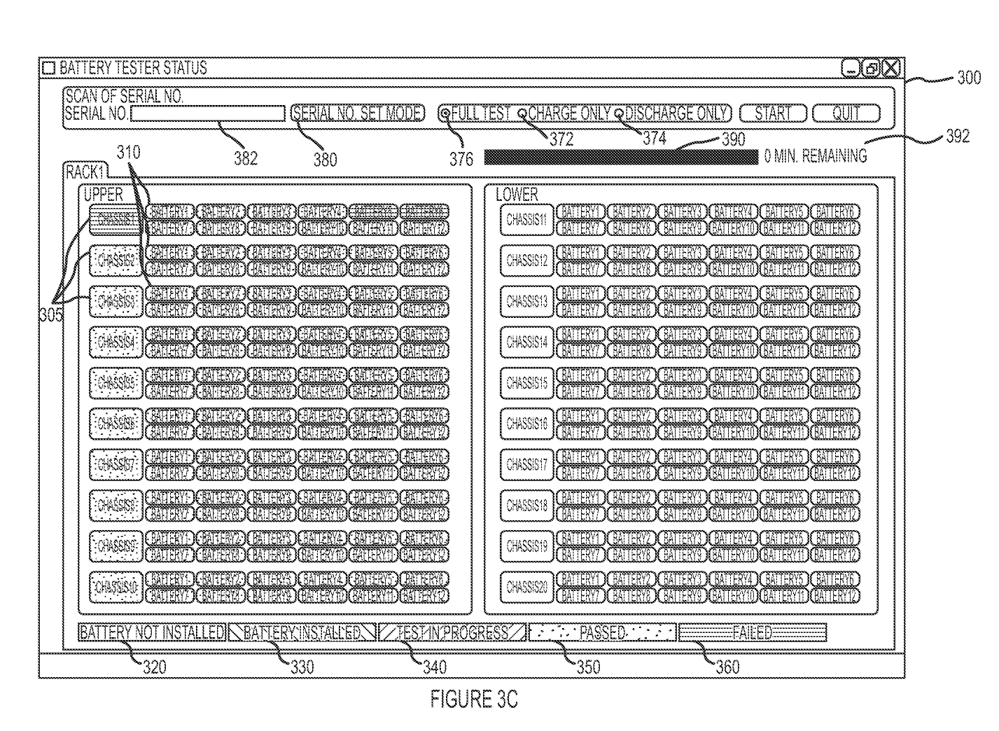

In one embodiment of the present invention, referring now to FIGS. 3A-3E, the user interface 116 displays (e.g., through a display screen) information for a plurality of batteries being tested. In this exemplary embodiment, the user interface 116 displays a window 300 that includes an icon 305 corresponding to each of twenty battery testing modules 135 (or “chassis”) in an exemplary battery testing system 130 (labeled “Rack 1” in window 300). The user interface 116 can also display information for multiple testing systems 130. For example, a user may select from multiple tabs (such as the tab labeled “Rack 1”) each corresponding to a different testing system 130 and labeled accordingly (e.g., “Rack 2,” Rack 3,” etc.).

Additionally, window 300 includes icons 310 corresponding to each of twelve battery interfaces 137 (and batteries coupled thereto) for each testing module 135. Each icon 310 may display an identifier associated with its respective battery. In window 300, for example, each icon 310 includes an alphanumeric identifier (i.e., “BATTERY1,” “BATTERY2,” etc.) for each battery. Alternatively, an icon 310 may include a serial number for each battery, or any other desired identifier. Such identifiers can be entered using window 300 by the user selecting the “serial no. set mode button” 380. The user may enter a serial number into text box 382, or the serial number can be received from a scanner 150 (such as a bar code reader) in communication with the control system 110.

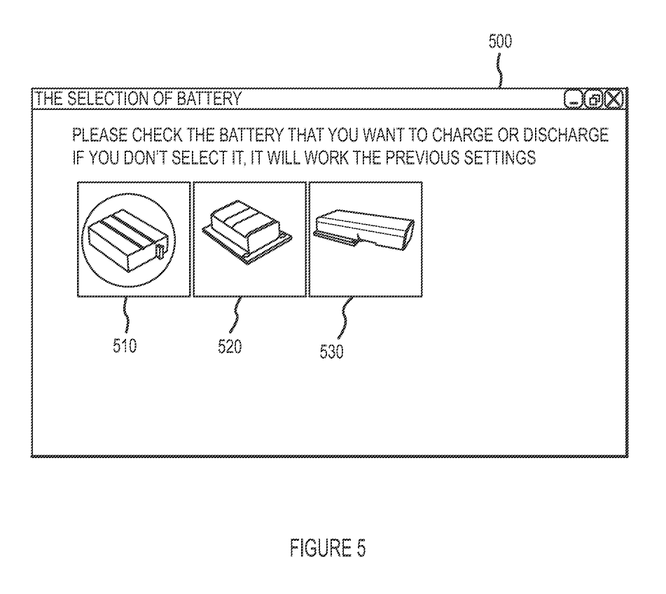

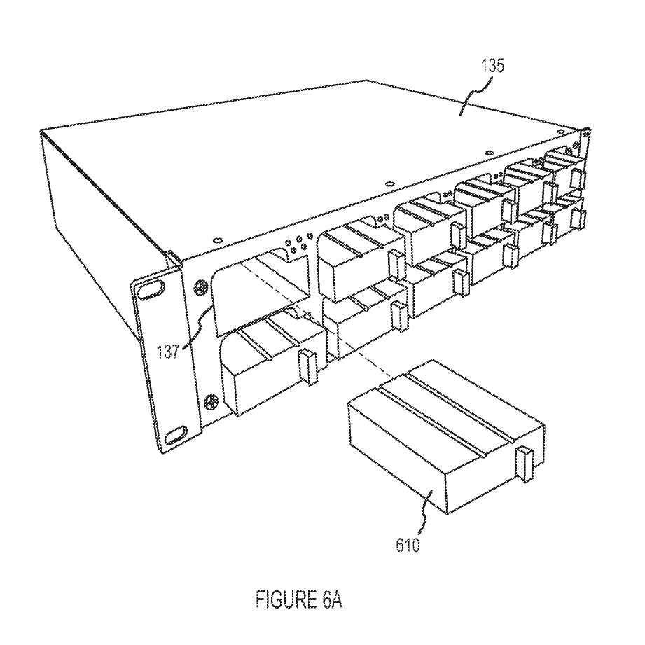

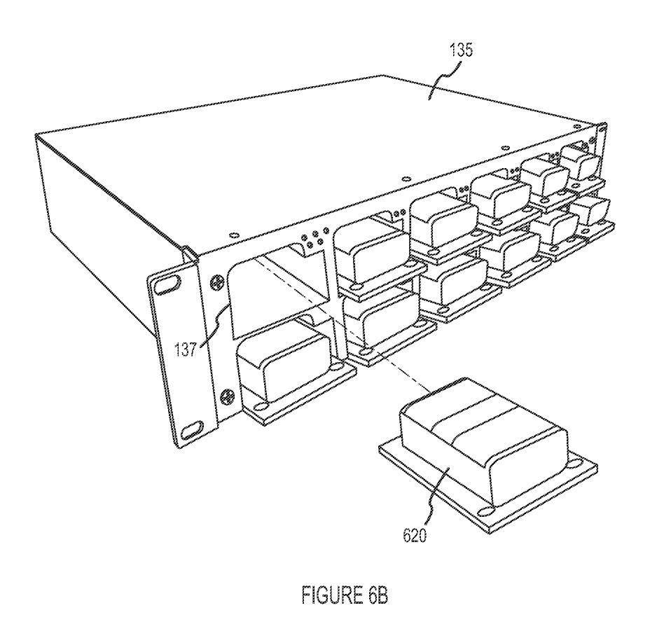

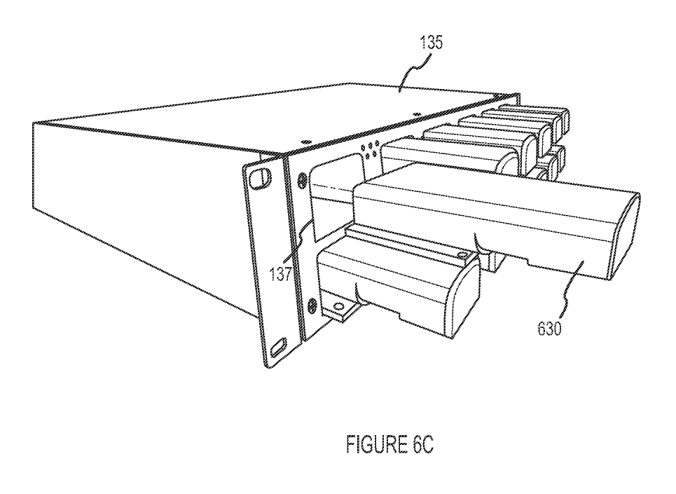

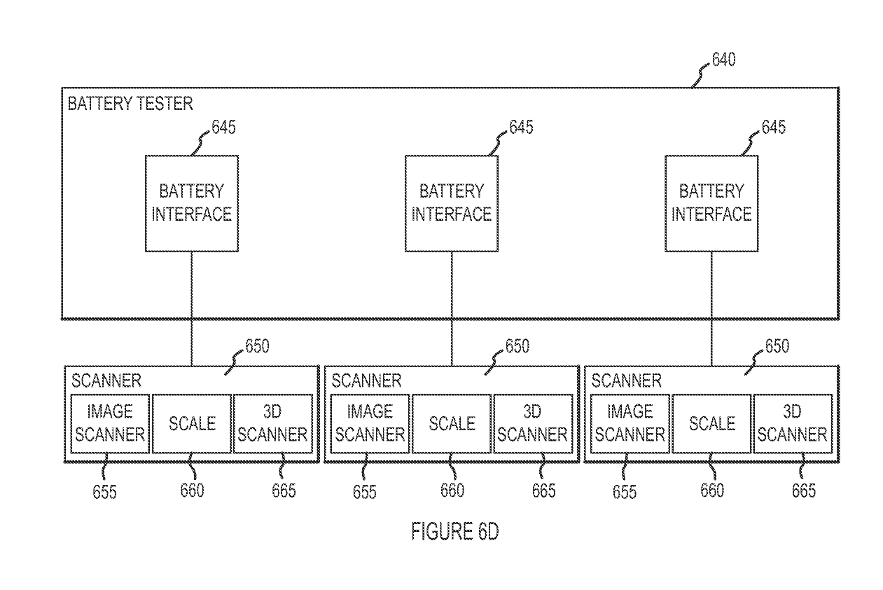

The user interface 116 may also display one or more images representative of a type (or types) of battery to, for example, allow a user to visually confirm the selection is correct. A user can also choose the type of battery he/she wishes to test by selecting the desired image through the user interface 116. In FIG. 5, for example, three images (510, 520, and 530) representing different battery types (illustrated in FIGS. 6A-6C as batteries 610, 620, and 630, respectively) are displayed within a window 500. Each of the images (510, 520, 530) also display the manufacturer and model of the respective battery. In this example, the user has selected image 510, which is circled in the window to indicate the selection. The control system 110 can then assign an identifier to the battery based on the image selection, or verify that a serial number or other identifier received by the control system 110 is consistent with the battery to be tested. Among other things, the visual identification of a battery in this manner helps catch and/or avoid errors in battery identification.

Referring again to FIGS. 3A-3D, each of the icons 305, 310 in the exemplary window 300 include an indicator (e.g., coloring and/or shading) corresponding to one or more conditions. In this exemplary embodiment, a legend showing possible conditions is displayed beneath the icons 305, 310 and include: a battery is not installed (320) in a battery interface 137; a battery is installed (330) in a battery interface 137; a test is in progress (340) for a battery coupled with a battery interface 137; a battery coupled with a battery interface 137 passed one or more tests (350); and a battery coupled with a battery interface 137 failed one or more tests (360). Any other desired condition can be conveyed using the icons 305, 310 or other feature of the user interface 116, including one or more icons or messages (not shown) for conveying testing status such as “pre-discharging,” “post-discharging,” and “charging.”

A user selects a test to perform on one or more batteries by, for example, using a mouse or other input device to select radio buttons 370 (corresponding to a full test), 372 (corresponding to a charge only test) or 374 (corresponding to a discharge only test). In FIGS. 3A-3D, the “full test” radio button 370 is selected. These tests are described in more detail below.

Information regarding the status of one or more tests can be displayed through the user interface 116. For example, as depicted in FIGS. 3B and 3C, a status bar 390 and time remaining indicator 392 are displayed to show the time remaining until testing is complete. Additionally, the icons 310 can display information pertaining to their respective batteries. In one exemplary embodiment, as shown in FIG. 3B, each of the battery interfaces 137 in the testing modules 135 labeled “Chassis1” through “Chassis10” are being used to test batteries. The voltage for each battery corresponding to an icon 310 of these testing modules 135 is displayed within the icon 310. The icons 310 may display any other desired information regarding a battery or test being performed on a battery, such as a power level for the battery corresponding to an icon 310 (e.g., the battery's accumulated power, consumed power, or remaining power). Likewise, icons 305 can be used to show test status information (e.g., by displaying the “test in progress” indicator 340 as shown in FIGS. 3A and 3B.

In FIG. 3C, testing is completed, as shown by status bar 390 and time remaining indicator 392. In this example, the icons 310 corresponding to the battery interfaces 137 (and batteries coupled thereto) in the testing modules 135 labeled “Chassis2” through “Chassis10” are each colored and/or shaded in accordance with condition 350, indicating that each of these batteries have passed their respective tests. Likewise, the icons 305 corresponding to these nine testing modules 135 are also colored and/or shaded in accordance with condition 350 to show that all the batteries tested by the respective modules 135 passed their tests.

By contrast, the icons 310 labeled “BATTERY5” and “BATTERY6” of “CHASSIS1” are colored and/or shaded in accordance with condition 360 to indicate the batteries associated with these icons 310 failed one or more tests. The icon 305 corresponding to the testing module 135 for “CHASSIS1” is also colored and/or shaded in accordance with condition 360 to show one or more batteries tested within the module 135 have failed at least one test.

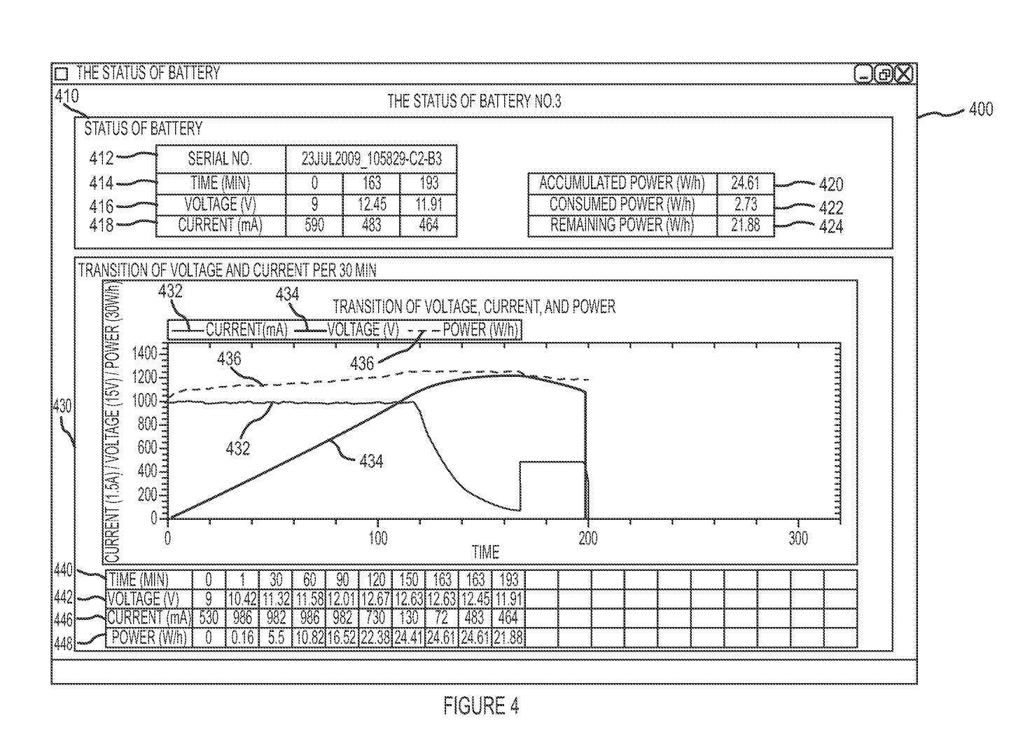

The user interface 116 can provide details on the status or results of one or more tests for any battery being tested. In the present exemplary embodiment, a user can view such information by selecting an icon 310 corresponding to a battery undergoing testing. FIG. 4 depicts a window 400 that can be displayed as a result of such a selection. The window 400 may include any desired information on the status of one or more tests, including: a test result, an elapsed time, a total expected time, a voltage, a current, an accumulated power, a consumed power, and/or a remaining power. Exemplary window 400 includes a status box 410 for a battery being tested. The status box 410 displays the serial number of the battery 412, three time periods 414 during the testing of the battery, three voltage measurements 416 corresponding to each of the three time periods 414, and three current measurements 418, also corresponding to the three time periods 414. Status box 410 also displays an accumulated power 420, consumed power 422, and remaining power 424 for the battery being tested. Window 400 also includes a section 430 that displays plots of current 432, voltage 434, and power 436 over the course of a test on the battery. Beneath the graph are numerical values (used to generate plots 432, 434, 436) showing a plurality of time periods 440, and voltage measurements 442, current measurements 446, and power measurements 448 for each of the time periods 440.

### Network 120

The control system 110, testing system 130, database 140, and any other component operating in conjunction with a system of the present invention may communicate in any desired manner. In one exemplary embodiment, the control system 110 communicates with the battery testing system 130 and database 140 through a network 120. Any suitable network may be used in conjunction with the present invention, such as a local area network (LAN), wide area network (WAN), wireless mobile telephony network, General Packet Radio Service (GPRS) network, wireless Local Area Network (WLAN), Global System for Mobile Communications (GSM) network, Personal Communication Service (PCS) network, Advanced Mobile Phone System (AMPS) network, and/or a satellite communication network. Likewise, systems and devices operating in conjunction with the present invention may communicate through any type of connection, such as a wired Internet connection, a wireless Internet connection, a cellular telephone network connection, a wireless LAN connection, a wireless WAN connection, an optical connection, and/or a USB connection.

The control system 110 and testing system 130 may send, receive, and process machine-readable data in any standard format (such as a MS Word document, MS Excel document, Adobe PDF file, ASCII text file, JPEG, or other standard format) as well as any proprietary format. Information communicated between the control system 110, testing system 130, and/or other systems and devices operating in conjunction with the present invention (such as information pertaining to the status of one or more tests) can be can be transmitted in real-time or near-real-time, and such information can be stored in a memory storage device or devices (such as memory 114).

### Battery Testing System 130

The battery testing system 130 tests one or more batteries. The battery testing system 130 may be configured to perform any number of tests on any number of batteries. The battery testing system 130 may test one or more batteries in any desired manner. In the exemplary embodiment depicted in FIG. 1, the battery testing system 130 includes a plurality of testing modules 135, with each module 135 comprising a plurality of battery testing interfaces 137. In this embodiment, each battery testing interface 137 comprises a receptacle that holds, and electrically couples with, a battery to be tested. The battery testing system 130 may include any number of testing modules and/or battery testing interfaces 137.

A battery testing system 130 may include one or more battery testing modules 135 and/or battery testing interfaces 137. In one exemplary embodiment, a battery test system 130 includes a plurality of test chassis 135 stored in racks. Alternatively, embodiments of the present invention may include battery test modules/chassis 135 and/or battery interfaces 137 in different locations that communicate with the battery test system 130 and/or control system 110 through, for example, the network 120. In this manner, the present invention can be used to monitor and control the testing of batteries at multiple locations, such as in multiple distribution sites throughout a region or country.

A battery testing system 130 of the present invention may be configured to couple with a single type of battery or with a plurality of different battery types. In one embodiment for example, referring now to FIGS. 6A-6C, the battery test module 135 is configured to couple with at least three types of batteries: a three-cell EMTA battery 610 (FIG. 6A), a two-cell EMTA battery 620, and a four-cell EMTA battery 630. While FIGS. 6A-6C show the same type of battery (610, 620, or 630) being used in each of the battery interfaces 137 of the test module 135, the battery testing system 130 may be configured to test different types of batteries coupled to the battery interfaces 137 of a single test module 135.

Similarly, a battery testing system 130 of the present invention may include battery modules configured to couple with any other type of battery. In this manner, the present invention allows multiple batteries (including different types of batteries) to be simultaneously tested and/or charged.

### Database 140

Systems and methods of the present invention may also store and retrieve data from one or more databases 140. The database 140 can be stored in the memory 114, or stored in another system or device in communication with the control system 110 and/or the battery testing system 130 (e.g., through the network 120). The database 140 can store any desired information, such as test settings, test results, information regarding individual batteries (such as battery characteristics and battery identifiers), and/or information regarding groups of batteries.

A database 140 operating in conjunction with the present invention may be implemented as a database management system (DBMS), a relational database management system (e.g., DB2, Oracle, SQL Server, My SQL, ACCESS, etc.), an object-oriented database management system (ODBMS), a file system, or in any another manner. The database 140 can be accessed by the control system 110 via a Structure Query Language (SQL) or in any other desired manner. The database 140 may be organized in any suitable manner, including as data tables or lookup tables. Association of certain data may be accomplished through any desired data association technique and data association may be accomplished manually and/or automatically.

In one exemplary embodiment, the database 140 stores test settings associated with an identifier, which is in turn associated with a battery or group of batteries. The control system 110 and/or the testing system 130 retrieves the test settings from the database 140, and the testing system 130 performs one or more tests in accordance with the test settings.

### Scanner 150

Systems and methods of the present invention may utilize one or more scanners 150 in identifying a battery to be tested. The present invention may utilize any number and type of scanners. In FIG. 1, scanner 150 is depicted as being in communication with the control system 110 via network 120, though the scanner 150 may communicate with any component of the present invention in any other desired manner. The scanner 150 may be a stand-alone device (as depicted in FIG. 1) or it can be integrated with the control system 110, battery tester 130, or any other component of the system 100.

The scanner 150 may be configured to measure one or more characteristics of a battery to be tested, and determine any suitable information about the battery, such as the battery's age, manufacturer, model, and/or the test history for the battery. Characteristics that may be measured include a configuration of the battery, dimension of the battery, a shape of at least a portion of the battery, a weight of the battery, a volume of the battery, an electrical characteristic of the battery (such as voltage, current, power, and/or resistance), a visual identifier associated with the battery, and/or an electronic identifier associated with the battery. Any characteristic of regarding the configuration of the battery, such as the number of cells in the battery, may be measured. A visual identifier may include one or more characters, numbers, symbols, bar codes, and/or any other identifier capable of being visually identified by a scanner. An electronic identifier may include any identifier capable of being read electronically, such as a code stored in a memory device of the battery. For example, some batteries, including many EMTA batteries, include a control board that can be interfaced with to obtain information about the battery.

The scanner 150 may include any number and type of distinct scanning devices, such that a scanner 150 can measure a plurality of different characteristics for the battery. Exemplary scanning devices that may be used in conjunction with the scanner 150 include a barcode reader, a laser scanner, an optical scanner, a radio-frequency identification (RFID) reader, and/or any other device capable of obtaining identification information from, or about, a battery to be tested.

In one exemplary embodiment of a the present invention, referring now to FIG. 6D, each battery interface 645 of a battery tester 640 includes, or is in communication with, a scanner 650. Each scanner 650 includes an image scanning device 655 (such as a bar code reader) for scanning a visual identifier associated with the battery (such as a bar code), and a scale 660 for measuring the weight of the battery. Each scanner 650 also includes a three-dimensional laser scanner 665 for creating a digital representation of the battery to identify the battery from a dimension, shape, volume, or other physical characteristic of at least a portion of the battery. A scanner of the present invention may include any number or type of other scanning devices.

### Exemplary Method

Various features of the system 100 can be implemented in hardware, software, or a combination of the two, and can be performed by the control system 110, battery test system 130, and/or another system or device operating in conjunction with the present invention. For example, the exemplary method depicted in FIG. 2 can be implemented by the exemplary system 100 depicted in FIG. 1. Components of a system implementing the method of FIG. 2 may communicate with each other remotely (e.g., through network 120), and thus need not be physically located together or near each other to perform various functions of the present invention. In this manner, the present invention may be used to initiate, control, monitor, and review the testing of batteries in different locations.

Various functions of the present invention may also be implemented through one or more software programs written using computer program languages such as, for example, ActiveX, Java, C, and/or C++. Any such software program, having computer-readable code, may be stored or provided on computer-readable media, thereby making a computer program product (i.e., an article of manufacture). The computer readable media may include, for instance, any of the exemplary media described for the memory 114, as well as any transmitting/receiving medium such as the Internet or other communication network or link. The article of manufacture containing the computer code may be made and/or used by executing the code directly from one medium, by copying the code from one medium to another medium, and/or by transmitting the code over a network.

The exemplary method in FIG. 2 includes identifying a battery (210), selecting one or more tests (220), retrieving test settings (230), modifying test settings (240), performing the one or more tests (250), and displaying the status of the one or more tests (260).

### Identifying a Battery (210)

A battery to be tested using systems and methods of the present invention is identified (210) to, among other things, determine appropriate tests and/or test settings for the battery. A battery to be tested can be identified in any suitable manner. For example, in one embodiment of the present invention, a battery is identified using an identifier associated with the specific battery to be tested. The identifier can be any word, number, code (such as a barcode), value, symbol, or other indicator capable of identifying the battery and distinguishing it from other individual batteries or groups of batteries. For example, the identifier may include information on the manufacturer and model of the battery.

An identifier used by systems and methods of the present invention may include any number of such indicators. In one embodiment of the present invention, for example, the identifier comprises a serial number displayed on the exterior of the battery. Among other things, identification of a battery allows its age, test history, and other characteristics to be tracked to avoid putting substandard batteries back into service.

The identifier can be received by the control system 110, battery tester 130, or any other suitable system or device operating in conjunction with the present invention. In one exemplary embodiment, the identifier is received by the control system 110 through the user interface 116 (e.g., from a human operator). Additionally, or alternatively, the identifier can be received by the control system 110 from a system or device in communication with the control system 110, such as a scanner 150, described above. For example, where the identifier includes a serial number, a user can manually provide the serial number to the control system 110 through the user interface 116 or scan a label adhered to the side of the battery that includes a barcode containing the serial number.

A battery to be tested can be identified based on a group to which it belongs. A battery may be grouped according to any characteristic(s) of the battery, such as the battery's manufacturer, the battery's model, the type of device the battery is designed to operate with, a configuration of the battery, a dimension of the battery, a shape of at least a portion of the battery, a weight of the battery, a volume of the battery, an electrical characteristic of the battery, a visual identifier associated with the battery, and an electronic identifier associated with the battery. These characteristics are described in more detail above. For example, for a system 100 configured to test EMTA batteries, batteries to be tested may be grouped according to the manufacturer and number of cells the battery has (e.g., ARRIS 4-cell batteries, ARRIS 2-cell batteries, SCIENTIFIC AMERICAN 3-cell batteries, MOTOROLA 3-cell batteries, etc.)

### Select Test(s) 220

One or more tests are selected to be run for one or more batteries. Tests can be selected in any manner. For example, tests can be selected through a user interface 116 operating in conjunction with the present invention. Tests can also be selected automatically by the control system 110, battery testing system 130, or any other system operating in conjunction with the present invention. The automatic selection of tests can be based on any desired criteria, such as one or more characteristics of a battery (e.g., a visual identifier associated with the battery). Any type of test may be selected. Exemplary tests that can be run are described in more detail below.

### Retrieve Test Settings 230

Test settings are retrieved to control the manner in which a battery is tested. Test settings can be retrieved from any source, such as from a user entering the settings through the user interface 116, and/or loaded from the memory 114 or other storage device and/or DB operating in conjunction with the present invention. Test settings that are manually entered through the user interface 116 can also be stored (e.g., in the memory 114 and/or database 140) and retrieved to configure future tests.

Stored test settings can be retrieved manually in response to input from a user through the user interface 116, and/or loaded automatically based on any desired criteria, such as one or more characteristics of a battery. In one embodiment, retrieved test settings are preferably configured in order to optimize the testing of a battery and/or group of batteries with which the test settings are associated. This helps test batteries in the most efficient and effective manner, without requiring the manual configuration of test settings.

### Modify Test Settings 240

The retrieved test settings can be modified as desired. Among other things, this allows batteries to be tested with a great deal of flexibility. Test settings can be modified manually, such as by user providing input through the user interface 116. Test settings can also be modified automatically, based on one more conditions or battery characteristics.

Any test settings may be retrieved and modified in conjunction with the present invention. In one exemplary embodiment, a user may retrieve, input, and/or modify test settings such as levels, limits, rates, and/or ranges of: time, voltage, current, and/or power used to test one or more batteries. Test settings can be modified for a single battery being tested, or for a group of batteries. Modifications to test settings can be temporary (e.g., only affecting a single test) or stored and retrieved for multiple tests.

### Perform Tests 250

The present invention performs one or more tests on one or more batteries. Tests can be performed in any order, for any duration, can be repeated any number of times on a battery or group of batteries. Tests are preferably configured based on the type of battery being tested, and the present invention may operate in conjunction with any number of standard or proprietary battery tests.

The present invention can be used to perform any suitable type test. For example, in one embodiment of the present invention, referring now to FIG. 3A, the present invention runs a test corresponding to a radio button selected by a user through the user interface 116 and corresponding to a full test 376, charge only test 372, or discharge only test 374. These tests can configured for different types of batteries using different chemistries. For example, “Charging Li-ion Batteries for Maximum Run Times,” Scott Dearborn, Power Electronics Technology, April 2005, which is incorporated herein by reference in its entirety, describes methods for and charging lithium-ion batteries (which are often used in cable modems and EMTAs).

### Discharge Test Portion

In the case that a user selects the full test 376, all batteries being tested are discharged for a predetermined amount of time to determine whether the voltage for each battery is below a predetermined threshold or (e.g., “low cutoff voltage level” and “minimum discharge time” defined in the test settings). If a battery's voltage is not below the predetermined threshold after discharging, an appropriate indicator of the battery's failure of the test (e.g., indicator 360) can be displayed through the user interface 116. The display of “pass” or “fail” indicators (such as indicators 350 and 360, respectively) can occur at any time, including during the running of the full test or after all tests have completed.

### Charge Test Portion

Batteries undergoing the full test are charged (e.g., using a predetermined voltage, current, and time duration specified in the test settings). Elements of the charge test may include, for example, whether the accumulated power in the battery is above a predetermined threshold, whether the maximum current during charging exceeded a predetermined threshold, whether the charging completed within a predetermined time frame, whether a battery cutoff circuit is operating properly, and/or any other suitable test.

A battery undergoing the full test is further discharged after the completion of the charge test(s). During this portion of the testing, it can be determined if the battery exhibits an appropriate voltage discharge slope, voltage level after charging, or any other suitable property or characteristic.

Alternately, when a user selects the “charge only” test (372), only the “Charge” portion of the test described above is performed. Likewise, when the “discharge only” (374) test is selected, only the “Discharge” portion of the test is performed.

### Display Test Results 260

As described above, test results, such as the passage or failure of one or more tests, can be displayed through the user interface 116 using indicators 350 and 360. Additionally, test results can be displayed through, for example, light-emitting diodes (LED's) or other devices in communication with the battery tester 130 and/or battery interfaces 137. In one embodiment, for example, each battery interface 137 includes, or is in communication with, a green LED and a red LED. If a battery coupled to the battery interface 137 passes one or more tests, the green LED is illuminated, whereas the red LED is illuminated if the battery fails one or more tests.

The present invention may display any other desired information regarding test results, such as the information shown on the screens depicted in FIGS. 3A-3C and 4, and described above. The display of test results may also include the creation and storage of one or more reports. In addition to test results, such reports can include any other desired information, such as a battery's characteristics (e.g., its age). In one exemplary embodiment, the present invention provides reports including statistics for tests performed over a period of time (e.g., daily tests and weekly tests).

Test results reports can be of any desired format. For example, the test results can be included in a file having a tokenized format such as standard ASCII text format, or any other suitable standardized file format, such as an MS Word document, MS Excel file, Adobe PDF file, or binary picture file (JPEG, bitmap, etc.). The data within such a file can be ordered in any manner and have any suitable delimiters, notations, or other features. The report may also have a unique and/or propriety format.

Test results can be conveyed to a human user, computer system, or other device (such as a printer). Communication with a user can be performed in any manner. For example, information such as the formatted report can be provided to one or more users using a web interface, an electronic mail message, a facsimile, an audio transmission, a voice message, a text message, and/or a video transmission. Information can be provided through an interactive voice response (IVR) system, a mobile computing device, a mobile telecommunications device, a computer system connected to a network, or by a human operator. Similarly, users can communicate information to systems operating in accordance with the present invention in any appropriate manner, including the methods listed above.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A method comprising:
identifying, by a computer system comprising a user interface, a provided battery to be tested;
receiving, through the user interface, a selection one or more tests to perform on the battery; and
performing, using a battery testing system, the one or more tests on the battery wherein the battery testing system is in communication with the computer system, and wherein the battery testing system comprises a battery interface for coupling with the battery.

2. The method of claim 1, wherein identifying the battery includes receiving an identifier associated with the battery.

3. The method of claim 2, further comprising receiving the identifier via a scanner.

4. The method of claim 3, wherein the scanner is in communication with the battery interface.

5. The method of claim 3, wherein the scanner comprises one or more scanning devices selected from the list consisting of:
a barcode reader;
a laser scanner;
an optical scanner;
a radio-frequency identification (RFID) reader; and
combinations thereof.

6. The method of claim 3, further comprising measuring a characteristic of the battery by the scanner.

7. The method of claim 6, wherein the measured characteristic of the battery includes one or more of:
a configuration of the battery;
a dimension of the battery;
a shape of at least a portion of the battery;
a weight of the battery;
a volume of the battery;
an electrical characteristic of the battery;
a visual identifier associated with the battery; and
an electronic identifier associated with the battery.

8. The method of claim 2, wherein the identifier is received through the user interface.

9. The method of claim 2, further comprising:
retrieving, from a database, test settings associated with the identifier; and
performing the one or more tests in accordance with the test settings.

10. The method of claim 9, wherein the test settings are further associated with a group to which the battery associated with the identifier belongs.

11. The method of claim 9, further comprising modifying the test settings in accordance with input received through the user interface.

12. The method of claim 1, wherein identifying the battery includes determining one or more of: a manufacturer of the battery and a model of the battery.

13. The method of claim 1, wherein the battery interface is configured to couple with a plurality of different battery types.

14. The method of claim 13, further comprising displaying a representative image of a type of the battery using the user interface.

15. The method of claim 13, further comprising displaying a plurality of images, each image representative of one or more of the plurality of battery types, and wherein identifying the battery to be tested includes receiving, through the user interface, a selection of one of the plurality of images.

16. The method of claim 1, further comprising displaying, through the user interface, a status for the one or more tests.

17. The method of claim 16, wherein the status for the one or more tests includes one or more of:
a test result;
an elapsed time;
a total expected time;
a voltage;
a current;
an accumulated power;
a consumed power; and
a remaining power.

18. The method of claim 1, wherein the battery testing system comprises a plurality of battery interfaces for coupling with a respective plurality of provided batteries.

19. The method of claim 18, further comprising displaying, using the user interface, a plurality of icons, each icon corresponding to a respective one of the plurality of batteries.

20. The method of claim 19, wherein each icon includes an indicator corresponding to one or more status conditions selected from the group consisting of:
a battery is coupled to the battery interface corresponding to the icon;
a battery is not coupled to the battery interface corresponding to the icon;
a test is in progress for a battery coupled to the battery interface corresponding to the icon;
a test passed for a battery coupled to the battery interface corresponding to the icon; and
a test failed for a battery coupled to the battery interface corresponding to the icon.

21. The method of claim 19, wherein each icon displays one or more of:
a voltage of the battery corresponding to the icon; and
a power level corresponding to the icon.

22. The method of claim 19, further comprising:
receiving, through the user interface, a selection of an icon from the plurality of icons by a user; and
displaying, using the user interface, a status for the one or more tests for the battery corresponding to the selected icon.

23. The method of claim 22, wherein the status for the one or more tests includes one or more of:
a test result;
an elapsed time;
a total expected time;
a voltage;
a current;
an accumulated power;
a consumed power; and
a remaining power.

24. The method of claim 1, further comprising storing, in a database, one or more of:
a status of at least one of the one or more tests;
a result of at least one of the one or more tests; and
an identifier associated with the battery.
